(19) United States
(12) Patent Application Publication
(10) Pub. No.: US 2026/0254064 A1
(43) Pub. Date: Aug. 27, 2026

(54) SECONDARY BATTERY

(71) Applicant: SAMSUNG SDI CO., LTD., Yongin-si (KR)

(72) Inventors: Dong Bok YANG, Yongin-si (KR); Joongyong PARK, Yongin-si (KR); Seokyo JEOUNG, Yongin-si (KR); Hanbyeol JANG, Yongin-si (KR); Eunseok OH, Yongin-si (KR); Jaehyeon YUN, Yongin-si (KR)

(21) Appl. No.: 19/541,916

(22) Filed: Feb. 17, 2026

(30) Foreign Application Priority Data
Feb. 21, 2025 (KR) 10-2025-0022931

(51) Int. Cl. H01M 50/538

(52) U.S. Cl. CPC H01M 50/538; H01M 2220/20

(57) ABSTRACT

A secondary battery according to some embodiments of the present disclosure may include an electrode assembly including a first electrode, a second electrode, and a separator disposed between the first electrode and the second electrode; a case configured to accommodate the electrode assembly such that the electrode assembly may be inserted through an opening at one end of the case; and a cover configured to seal the opening of the case. The case may include an electrolyte injection port, a first electrode terminal, and a second electrode terminal. The electrolyte injection port may be sealed by the first electrode terminal.

### CROSS-REFERENCE TO RELATED APPLICATION

This application claims priority under 35 U.S.C. §119 to Korean Patent Application No. 10-2025-0022931, filed in the Korean Intellectual Property Office on Feb. 21, 2025, the entire contents of which are hereby incorporated by reference.

### BACKGROUND

### Field

The present disclosure relates to a secondary battery.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors (e.g., in hybrid vehicles and electric vehicles) and for storing power (e.g., home and/or utility scale power storage). A secondary battery generally includes an electrode assembly composed of a positive electrode and a negative electrode, a case accommodating the same, and electrode terminals connected to the electrode assembly.

A conventional secondary battery consists of a positive electrode, a negative electrode, an electrolyte, and a separator accommodated inside a case, and a current flows because ions move between a positive electrode and a negative electrode through an electrolyte. An electrolyte injection port formed in the conventional secondary battery case is separated from an electrode terminal and is formed in a small, circular shape. However, a problem lies in that a resistance inside a cell rises because an electrolyte injection amount may not be sufficient due to the small area of the electrolyte injection port.

The above information disclosed in this Background section is for the enhancement of understanding of the background of the present disclosure, and, therefore, it may contain information that does not constitute related (or prior) art.

### SUMMARY

Some embodiments of the present disclosure are aimed to provide a secondary battery for solving the above-described problems.

These and other aspects and features of the present disclosure will be described in or will be apparent from the following description and the drawings of embodiments of the present disclosure.

A secondary battery according to some embodiments of the present disclosure may include an electrode assembly including a first electrode, a second electrode, and a separator disposed between the first electrode and the second electrode; a case configured to accommodate the electrode assembly such that the electrode assembly may be inserted through an opening at one end of the case; and a cover configured to seal the opening of the case. The case may include an electrolyte injection port, a first electrode terminal, and a second electrode terminal. The electrolyte injection port may be sealed by the first electrode terminal.

In some embodiments, the first electrode terminal may include a center having a shape corresponding to the electrolyte injection port, an extension extending outwardly from the center of the first electrode terminal, and a bending part configured to connect the center of the first electrode terminal to the extension of the first electrode terminal.

In some embodiments, a portion of the case corresponding to a periphery of the electrolyte injection port may have a step, the extension of the first electrode terminal may be mounted on and fixed to the step, and an upper surface of the center of the first electrode terminal may be positioned at a higher level than an upper surface of the case.

In some embodiments, the center of the first electrode terminal may be inserted and fixed into the electrolyte injection port, the extension of the first electrode terminal may be mounted on and fixed to a surface of the case corresponding to a periphery of the electrolyte injection port, and an upper surface of the center of the first electrode terminal may be positioned at a lower level than an upper surface of the case.

In some embodiments, a horizontal length of the center of the first electrode terminal may be greater than a horizontal length of the electrolyte injection port.

In some embodiments, a portion of the case corresponding to a periphery of the electrolyte injection port may have a step. A thickness of the extension of the first electrode terminal may be greater than or the same as a depth of the step.

In some embodiments, the secondary battery may further include a metal support placed at the center of the first electrode terminal.

In some embodiments, the electrolyte injection port may have a polygonal, circular, or oval shape.

In some embodiments, a material of at least one of the case and the cover may include stainless use steel.

In some embodiments, the secondary battery may further include an auxiliary electrolyte injection port formed between the first electrode terminal and the second electrode terminal on at least one surface of the case.

In some embodiments, the first electrode may be electrically connected to the case.

A secondary battery according to some embodiments of the present disclosure may include an electrode assembly including a first electrode, a second electrode, and a separator disposed between the first electrode and the second electrode; a case configured to accommodate the electrode assembly inserted through an opening formed at one end of the case; a cover configured to seal the opening of the case; and an insulating plate placed between the electrode assembly and the case. The case may include an electrolyte injection port; a first electrode terminal; and a second electrode terminal. The electrolyte injection port may be sealed by the first electrode terminal.

In some embodiments, the insulating plate may include a first electrode hole corresponding to the first electrode and a second electrode hole corresponding to the second electrode.

In some embodiments, the first electrode terminal may include a center having a shape corresponding to the electrolyte injection port, an extension extending outwardly from the center of the first electrode terminal, and a bending part that connects the center of the first electrode terminal to the extension of the first electrode terminal.

In some embodiments, a portion of the case corresponding to a periphery of the electrolyte injection port may have a step, the extension of the first electrode terminal may be mounted on and fixed to the step, and an upper surface of the center of the first electrode terminal may be positioned at a higher level than an upper surface of the case.

In some embodiments, the center of the first electrode terminal may be inserted and fixed into the electrolyte injection port, the extension of the first electrode terminal may be mounted on and fixed to a surface of the case corresponding to a periphery of the electrolyte injection port, and an upper surface of the center of the first electrode terminal may be positioned at a lower level than an upper surface of the case.

In some embodiments, a horizontal length of the center of the first electrode terminal may be greater than a horizontal length of the electrolyte injection port.

In some embodiments, a portion of the case corresponding to a periphery of the electrolyte injection port may have a step. A thickness of the extension of the first electrode terminal may be greater than or the same as a depth of the step.

In some embodiments, the electrolyte injection port may have a polygonal, circular, or oval shape.

In some embodiments, the secondary battery may further include an auxiliary electrolyte injection port formed between the first electrode terminal and the second electrode terminal on at least one surface of the case. The insulating plate may include an electrolyte injection port hole corresponding to the auxiliary electrolyte injection port.

According to some embodiments of the present disclosure, a size of an electrolyte injection port may be increased by placing an electrode terminal at a position where the electrolyte injection port is formed on one surface of a secondary battery case, which allows a greater amount of an electrolyte to be injected through the electrolyte injection port. Accordingly, the above-described embodiments may resolve an issue of internal cell resistance caused by an insufficient amount of the electrolyte.

In addition, the electrolyte injection port may be sealed by an electrode terminal having a press-fit engagement, thereby minimizing an amount of leakage of the electrolyte from the secondary battery case.

However, aspects and features of the present disclosure are not limited to the embodiments described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view illustrating a secondary battery according to some embodiments of the present disclosure.

FIG. 2 is a view illustrating one surface of a secondary battery case according to some embodiments of the present disclosure.

FIG. 3 is a view illustrating an internal structure of a secondary battery according to some embodiments of the present disclosure.

FIG. 4 is a view illustrating one surface of a secondary battery case according to some embodiments of the present disclosure.

FIG. 5 is a view illustrating one surface of a secondary battery case according to some embodiments of the present disclosure.

FIG. 6 is a view illustrating one surface of a secondary battery case according to some embodiments of the present disclosure.

FIG. 7 is a view illustrating a press-fit structure between an electrolyte injection port and an electrode terminal of a secondary battery according to some embodiments of the present disclosure.

FIG. 8 is a view illustrating a press-fit structure of an electrode terminal where an electrolyte injection port and a metal support of a secondary battery are arranged according to some embodiments of the present disclosure.

FIG. 9 illustrates a structure of which an electrolyte injection port of a secondary battery is sealed by an electrode terminal according to some embodiments of the present disclosure.

FIG. 10 illustrates a structure of which an electrolyte injection port of a secondary battery is sealed by an electrode terminal according to some embodiments of the present disclosure.

FIG. 11 illustrates a structure of which an electrolyte injection port of a secondary battery is sealed by an electrode terminal according to some embodiments of the present disclosure.

FIG. 12 illustrates a structure of which an electrolyte injection port of a secondary battery is sealed by an electrode terminal with a metal support according to some embodiments of the present disclosure.

FIG. 13 illustrates a structure of which an electrolyte injection port of a secondary battery is sealed by an electrode terminal with a metal support according to some embodiments of the present disclosure.

FIG. 14 illustrates a structure of which an electrolyte injection port of a secondary battery is sealed by an electrode terminal with a metal support according to some embodiments of the present disclosure.

FIG. 15 is a view illustrating the internal structure of a secondary battery according to some embodiments of the present disclosure.

FIG. 16 is a view illustrating an insulating plate of a secondary battery according to some embodiments of the present disclosure.

FIG. 17 is a view illustrating an insulating plate of a secondary battery according to some embodiments of the present disclosure.

FIG. 18 is a view illustrating a welded shape of an electrode terminal of a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the scope of the disclosure.

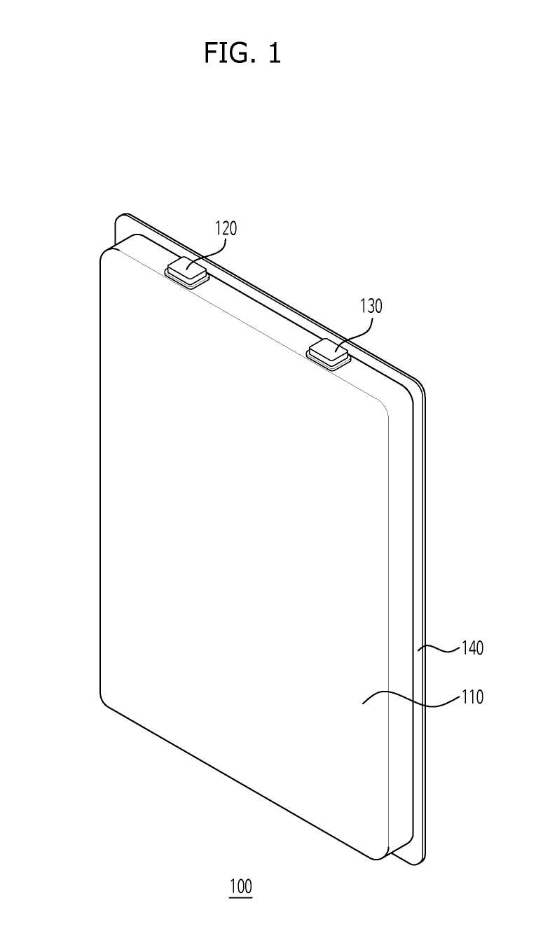

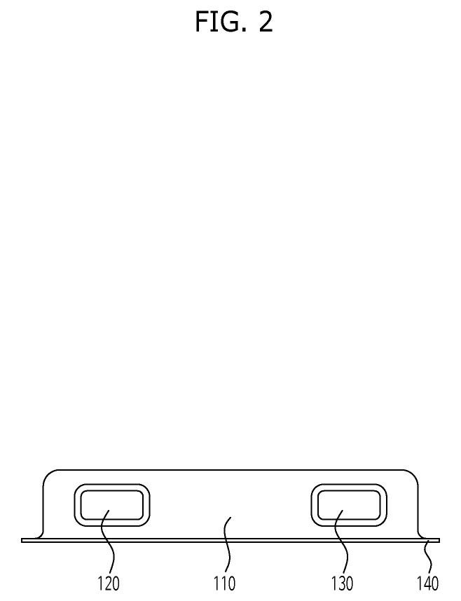

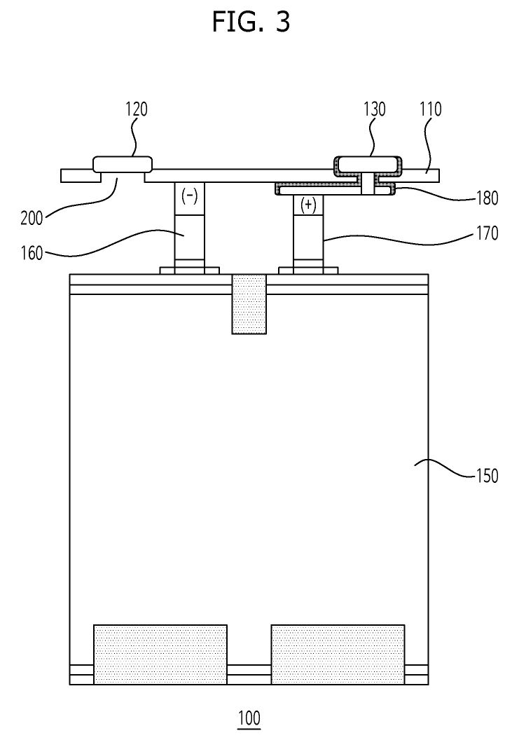

FIG. 1 is a perspective view illustrating a secondary battery 100 according to some embodiments of the present disclosure. FIG. 2 is a view illustrating one surface of a case 110 of the secondary battery 100 according to some embodiments of the present disclosure, and FIG. 3 is a view illustrating an internal structure of the secondary battery 100 according to some embodiments of the present disclosure.

Referring to FIG. 1, a secondary battery 100 according to some embodiments of the present disclosure may include an electrode assembly (not shown) including a first electrode, a second electrode, and a separator disposed between the first electrode and the second electrode, a case 110 configured to accommodate an electrode assembly inserted through an opening formed at one end, and a cover 140 configured to seal the opening of the case 110. At least one surface of the case 110 may include an electrolyte injection port, a first electrode terminal 120, and a second electrode terminal 130, and the electrolyte injection port may be sealed by the first electrode terminal 120.

The secondary battery 100 illustrated in FIG. 1 may be a can-type secondary battery made of stainless steel (SUS) material, aluminum material, etc., which has a sufficient strength to have high resistance to an external impact. However, the secondary battery according to the present disclosure is not limited thereto but may be one of various types of secondary batteries such as pouch-type, square-type, or circular-type.

An electrode assembly may be formed by winding or stacking a first electrode plate, a separator, and a second electrode plate, which are formed as thin plates or films. When the electrode assembly is a wound stack, a winding axis may be parallel to a longitudinal direction (e.g., a y direction) of the case 110. In some embodiments, the electrode assembly may be a stack type rather than a winding type, and a shape of the electrode assembly is not limited in the present disclosure. In addition, the electrode assembly may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case 110, and a number of electrode assemblies in the case 110 is not limited in the present disclosure. The first electrode plate of the electrode assembly may act as a negative electrode, and the second electrode plate may act as a positive electrode. Of course, the reverse is also possible. Therefore, the first electrode plate of the electrode assembly may act as a positive electrode, and the second electrode plate may act as a negative electrode.

The first electrode plate may be formed by applying a first electrode active material, such as graphite or carbon, to a first electrode current collector formed of a metal foil, such as copper, a copper alloy, nickel, or a nickel alloy. The first electrode plate may include a first electrode tab (e.g., a first uncoated portion) that is a region to which the first electrode active material is not applied. The first electrode tab may act as a current flow path between the first electrode plate and the first current collector. In some embodiments, when the first electrode plate is manufactured, the first electrode tab may be formed by being cut in advance to protrude to one side of the electrode assembly, or the first electrode tab may protrude to one side of the electrode assembly more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab (e.g., a second uncoated portion) that is a region to which the second electrode active material is not applied. The second electrode tab may act as a current flow path between the second electrode plate and the second current collector. In some embodiments, the second electrode tab may be formed by being cut in advance to protrude to the other side of the electrode assembly compared to the first electrode tab (e.g., the side opposite to that of the first electrode tab) when the second electrode plate is manufactured, or the second electrode plate may protrude to the other side of the electrode assembly more than (e.g., farther than or beyond) the separator without being separately cut. However, this is merely one example, and the second electrode tab and the first electrode tab may protrude in the same direction.

The separator may include a porous substrate and a coating layer including an organic material, an inorganic material, or a combination thereof on one or both surfaces of the porous substrate.

The porous substrate may be a polymer film formed of any one of a polyolefin (such as polyethylene and polypropylene), a polyester (such as polyethylene terephthalate and polybutylene terephthalate), polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y2O₃, SrTiO₃, BaTiO₃, Mg(OH)₂, boehmite, or a combination thereof, but the inorganic material is not limited thereto.

The organic material and the inorganic material may be mixed in one coating layer, or a coating layer including an organic material and a coating layer including an inorganic material may be stacked.

The case 110 may include an opening at one end to accommodate an electrode assembly (not shown). The case 110 may include a body including an accommodation space for accommodating an electrode assembly (not shown), and a flange extending along a vertical direction from the upper end of the body to surround the accommodation space. The body may consist of a bottom and four of sidewalls that vertically extend from the bottom, and the accommodation space of the body may be defined by the bottom and the side walls. The side wall may consist of two long sides opposite to each other and two short sides opposite to each other. The case 110 may be provided in a box-shape with one open end. Therefore, the electrode assembly (not shown) may be supported by the bottom of the case and may be surrounded by four side walls inside the case 110. Referring to FIG. 1, the bottom of the case 110 may be vertically formed from the plane.

The flange may extend along a horizontal direction from the upper end of the body to surround the accommodation space. In some embodiments, the flange may include a flat plate extending with a predetermined width along the periphery of the body and may be made of the material substantially the same as the body.

In the drawings, the body is illustrated as including a flange, but the present disclosure is not limited thereto, as the flange may be cut as much as possible to be eliminated or the flange may not be included.

At least one surface of the case 110 may include an electrolyte injection port, the first electrode terminal 120, and the second electrode terminal 130. The electrolyte injection port may be a through-hole formed on at least one side of the case 110, or after the case 110 and the cover 140 are bonded and sealed, and the through-hole may be formed to inject an electrolyte into the case 110. The electrolyte injection port may be sealed by a sealer after an electrolyte is injected. One of the first electrode terminal 120 or the second electrode terminal 130 may be used as a sealer that seals the electrolyte injection port. The through-hole through which one of the first electrode terminal 120 or the second electrode terminal 130 is placed on at least one surface of the case 110 may function as the electrolyte injection port. In addition, the electrolyte injection port may not be formed on the side of the case 110, separately from the first electrode terminal 120 and the second electrode terminal 130.

The first electrode terminal 120 and the second electrode terminal 130 may be disposed on one side of the case 110 with a predetermined distance as in a conventional secondary battery 100. The positions of the first electrode terminal 120 and the second electrode terminal 130 are not limited as shown in FIG. 1, but may vary in different embodiments.

Referring to FIG. 2, according to some embodiments of the present disclosure, an electrolyte injection port formed on one surface of the case 110 of the secondary battery 100 may be sealed by the first electrode terminal 120. The first electrode terminal 120 may have a shape corresponding to the electrolyte injection port to seal the electrolyte injection port, thereby preventing the electrolyte from leaking from the electrolyte injection port. In addition, the electrolyte injection port having the shape corresponding the first electrode terminal 120 may allow a larger area of the electrolyte injection port than the conventional electrolyte injection port.

Referring to FIG. 3, according to some embodiments of the present disclosure, an electrolyte injection port 200 may be sealed by the first electrode terminal 120, and a first electrode tab 160 of an electrode assembly 150 may be electrically connected to the case 110. The first electrode tab 160 may not be directly connected to the first electrode terminal 120, but may be connected to the case 110, which is a conductor, thereby allowing the electrical connection between an external power supply and a load, and ensuring the flow path of the electrolyte entering through the electrolyte injection port 200. However, the present disclosure is not limited thereto; the first electrode tab 160 may be directly connected to the first electrode terminal 120.

The second electrode terminal 130 may be electrically connected to a second electrode tab 170. Additionally, an insulating layer 180 may be disposed between the case 110 and the second electrode terminal 130 to prevent short-circuits, thereby preventing the electrical connection between the second electrode terminal 130 and the case 110. The second electrode terminal 130 may have a rivet structure, but the second electrode terminal 130 is not limited thereto.

Referring to FIG. 1, the secondary battery 100 may include the cover 140 coupled to a flange part to seal the opening of the case 110. The cover 140 may be a flat plate arranged on the upper part of the case 110 to seal the accommodation space of the body. The cover 140 may be a flat plate large enough to cover the flange part to form surface contact with the flange part. The lower surface of the case 110 may form surface contact with the upper surface of the flange part.

At least one of the case 110 and the cover 140 may include stainless use steel (SUS). Both the case 110 and the cover 140 may include stainless use steel (SUS). The flange part and the cover 140 may be bonded by laser welding. However, the method of bonding is not limited thereto, as various bonding methods may be used to seal the case 110. The cover 140 and the flange part of the case 110 may be bonded by laser welding, ultrasonic welding, brazing, laser brazing, welding, soldering, etc.

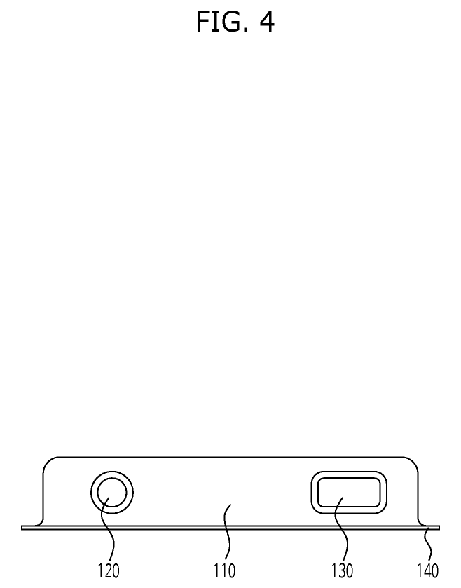

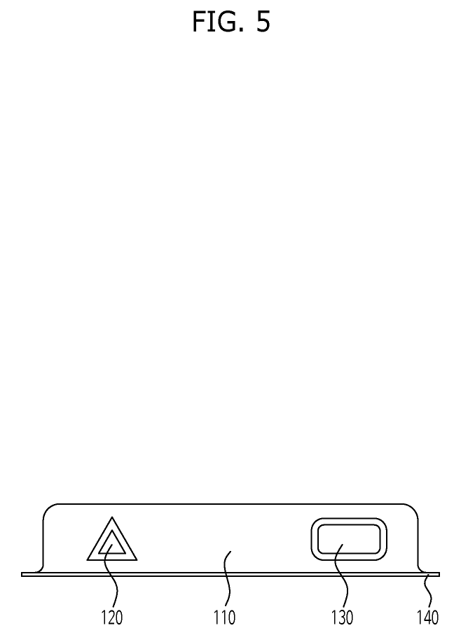

FIGS. 4 and 5 are views illustrating one surface of the case 110 of the secondary battery 100 according to some embodiments of the present disclosure.

The electrolyte injection port included in the secondary battery 100 may have a polygonal, circular, or oval shape. In some embodiments, because the electrolyte injection port is sealed by the first electrode terminal 120, the first electrode terminal 120 may have a polygonal, circular, or oval shape corresponding to the electrolyte injection port. The electrolyte injection port may have a circular shape as in FIG. 4, or a triangular shape as in FIG. 5. However, the shape of the electrolyte injection port is not limited thereto, and the electrolyte injection port may have various shapes such as a square, a parallelogram, a trapezoid, and an ellipse in consideration of the position of the electrolyte injection port formed in the case 110, the area in which the electrolyte injection port is formed, etc.

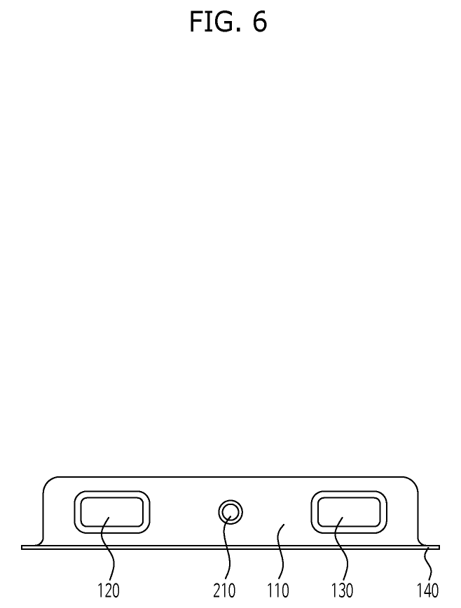

FIG. 6 is a view illustrating one surface of the case 110 of the secondary battery 100 according to some embodiments of the present disclosure.

Referring to FIG. 6, the secondary battery 100 according to some embodiments of the present disclosure may further include an auxiliary electrolyte injection port 210 formed between the first electrode terminal 120 and the second electrode terminal 130 on at least one surface of the case 110. To increase the area of the electrolyte injection port, a through-hole through which the first electrode terminal 120 is arranged, which is formed on one surface of the case 110, may be used as an electrolyte injection port, but also the auxiliary electrolyte injection port 210 may be additionally formed, apart from the first electrode terminal 120 and the second electrode terminal 130. The number of auxiliary electrolyte injection ports 210 is not limited to what is shown in FIG. 6, and the electrolyte injection amount may be increased by adding more auxiliary electrolyte injection ports 210, as long as there is sufficient space to accommodate the auxiliary electrolyte injection ports on the one surface of the case 110 along with the first electrode terminal 120 and the second electrode terminal 130.

The auxiliary electrolyte injection port 210 may have a polygonal, circular, or oval shape similar to the electrolyte injection port in which the first electrode terminal 120 is placed.

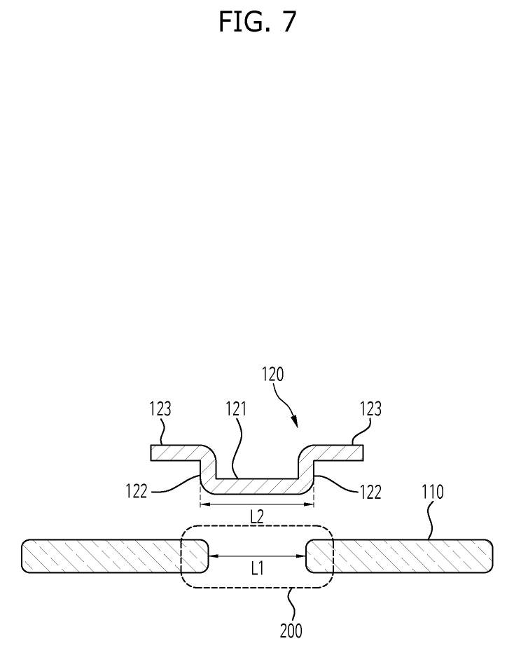

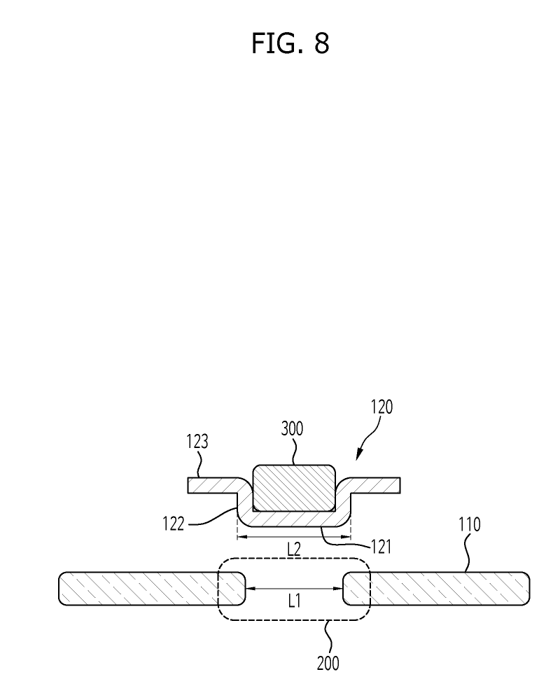

FIG. 7 is a view illustrating a press-fit engagement between an electrolyte injection port and an electrode terminal of a secondary battery according to some embodiments of the present disclosure. FIG. 8 is a view illustrating a press-fit engagement between an electrolyte injection port of a secondary battery and an electrode terminal with a metal support according to some embodiments of the present disclosure.

Referring to FIG. 7, the first electrode terminal 120 disposed in the case 110 of the secondary battery 100 may include a center 121 having a shape corresponding to the electrolyte injection port 200, an extension 123 that extends outwardly from the center 121, and a bending part 122 that connects the center 121 and the extension 123. When the center 121 is parallel with a line that horizontally connects the case 110 to the electrolyte injection port 220, and the extension 123 is opposite to one side of the case 110, the first electrode terminal 120 may be coupled in the direction of the electrolyte injection port 200 to seal the electrolyte injection port 200. Accordingly, the bending part 122 and the extension 123 may be coupled in contact with a part of the case 110 at a periphery of the electrolyte injection port 200.

A horizontal length L2 of the center 121 of the first electrode terminal 120 may be greater than a horizontal length L1 of the electrolyte injection port 200. Accordingly, the first electrode terminal 120 may be press-fitted into the electrolyte injection port 200, thereby stably fixing the first electrode terminal 120 and minimizing the amount of electrolyte leaked from the electrolyte injection port 200.

Referring to FIG. 8, the secondary battery 100 may further include a metal support 300 disposed at the center 121. The metal support 300 may support the inner sides of the center 121 and the bending part 122 of the first electrode terminal 120 or may strengthen the press-fit engagement of the first electrode terminal 120 by applying pressure onto the first electrode terminal 120.

A portion of the metal support 300 may be mounted and coupled onto the inner sides of the center 121 and the bending part 122. The metal support 300 may be coupled to the first electrode terminal 120 by welding. The upper surface of the metal support 300 may be higher than the upper surface of the extension 123 of the first electrode terminal 120. However, the shape of the metal support 300 is not limited thereto, as any shape may be possible as long as the metal support 30 strengthens the press-fit engagement of the first electrode terminal 120. The metal support 300 may have a conductivity that allows current flow to an external power or a load through the electrode terminal without interference.

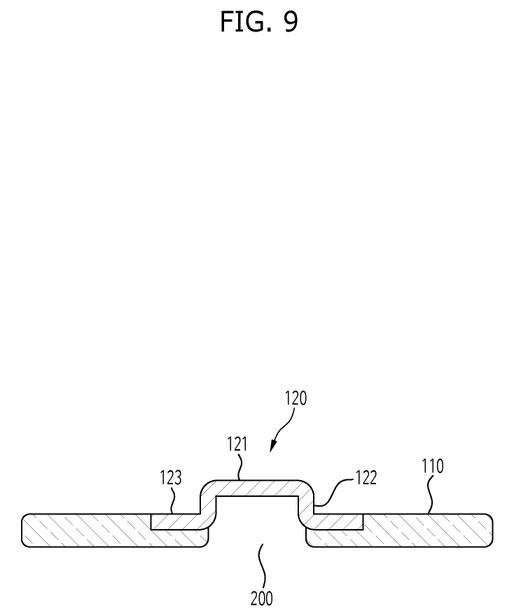

FIG. 9 is a view illustrating a structure of which an electrolyte injection port 200 of a secondary battery 100 is sealed by a first electrode terminal 120.

Referring to FIG. 9, in the secondary battery 100, there may be a step at a portion of the case 110 corresponding to the periphery of the electrolyte injection port 200, and the extension 123 of the first electrode terminal 120 may be mounted and may be fixed at the step. An upper surface of the center 121 of the first electrode terminal 120 may be positioned higher than an upper surface of the case 110. A horizontal length of the center 121 may be greater than or smaller than the horizontal length of the electrolyte injection port 200. When the horizontal length of the center 121 is greater than a horizontal length of the electrolyte injection port 200, a horizontal length of the step formed at the portion of the case 110 corresponding to the periphery of the electrolyte injection port 200 may increase proportionally.

In some embodiments, a step may be at the portion of the case 110 corresponding to the periphery of the electrolyte injection port 200, and the thickness of the extension 123 may be greater than or the same as a depth of the step. The extension 123 of the first electrode terminal 120 may be mounted at the step of the case 110 and may be fixed by welding, although a method of fixing the extension 123 is not limited thereto.

When the first electrode terminal 120 is coupled as shown in FIG. 9, the first electrode terminal 120 may be coupled to the case 110 by welding to seal the electrolyte injection port 200.

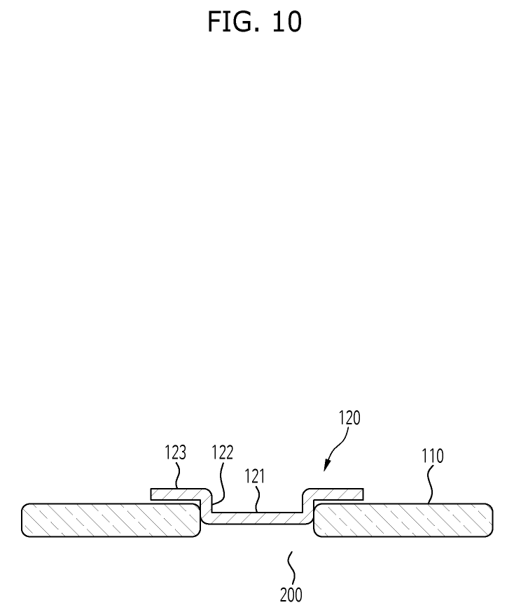

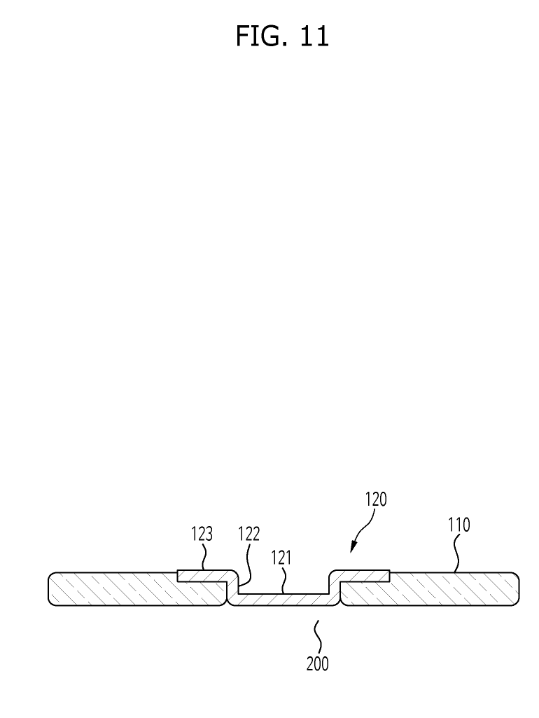

FIG. 10 and FIG. 11 are views illustrating a structure of which the electrolyte injection port 200 of the secondary battery 100 is sealed by the first electrode terminal 120.

Referring to FIG. 10, in the secondary battery 100, the center 121 of the first electrode terminal 120 may be inserted and may be fixed into the electrolyte injection port 200, and the extension 123 may be mounted and may be fixed onto a surface of the case 110 corresponding to the periphery of the electrolyte injection port 200. The upper surface of the center 121 may be lower than the upper surface of the case 110. The horizontal length of the center 121 of the first electrode terminal 120 may be greater than the horizontal length of the electrolyte injection port 200 and may be coupled by press-fitting. The extension 123 of the first electrode terminal 120 may be mounted onto the surface of the case 110 corresponding to the periphery of the electrolyte injection port 200 and may be fixed by welding, etc. The first electrode terminal 120 may contact the case 110 to function as a flow path that moves a current to an external power or a load.

Referring to FIG. 11, in the secondary battery 100, the center 121 of the first electrode terminal 120 may be inserted and may be fixed into the electrolyte injection port 200, and the extension 123 may be mounted and may be fixed onto the step formed at a portion of the case 110 corresponding to the periphery of the electrolyte injection port 200. The lower surface of the center 121 of the first electrode terminal 120, which is inserted and is fixed into the electrolyte injection port 200, may be higher than the lower surface of the case 110. A step may be at the portion of the case 110 corresponding to the periphery of the electrolyte injection port 200, and the thickness of the extension 123 may be greater than or the same as the depth of the step. The extension 123 of the first electrode terminal 120 may be mounted at the step of the case 110 corresponding to the periphery of the electrolyte injection port 200 and may be fixed by welding, etc.

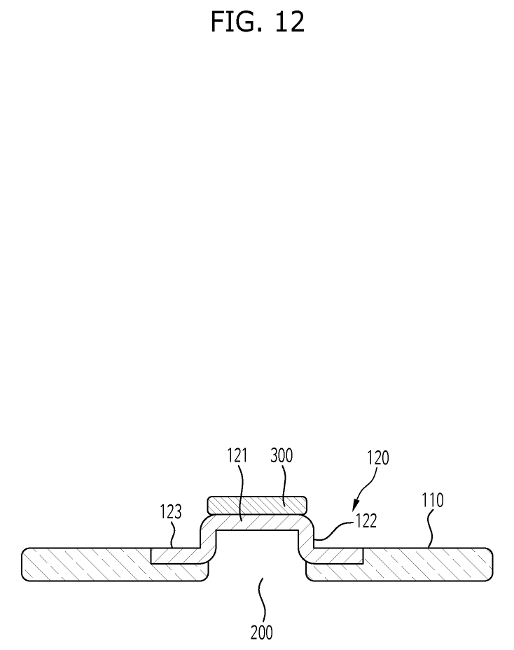

FIG. 12 to FIG. 14 illustrate a structure of which the electrolyte injection port 200 of the secondary battery 100 is sealed by the first electrode terminal 120 with the metal support 300.

Referring to FIG. 12, in the secondary battery 100 according to some embodiments, a step may be at a portion of the case 110 corresponding to the periphery of the electrolyte injection port 200, and the extension 123 of the first electrode terminal 120 may be mounted and may be fixed onto the step. The upper surface of the center 121 of the first electrode terminal 120 may be positioned higher than the upper surface of the case 110. In addition, the metal support 300 may be disposed at the center 121 of the first electrode terminal 120. The metal support 300 may have a conductivity that allows current to flow from the electrode terminal to an external power supply or a load without interference and may enhance a fixing of the first electrode terminal 120 to the case 110 by increasing a rigidity of the center 121 of the first electrode terminal 120 or applying pressure to the center 121.

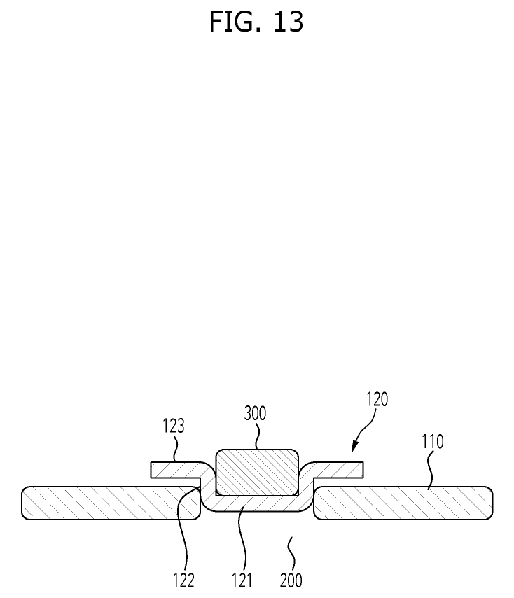

Referring to FIG. 13, in the secondary battery 100 according to some embodiments, as shown in FIG. 10, the center 121 of the first electrode terminal 120 may be inserted and may be fixed into the electrolyte injection port 200, and the extension 123 may be mounted and may be fixed onto the surface of the case 110 corresponding to the periphery of the electrolyte injection port 200. The upper surface of the center 121 may be positioned lower than the upper surface of the case 110. The metal support 300 may be disposed at the center 121 of the first electrode terminal 120. With respect to the metal support 300, the description thereof for FIG. 8 may be applied.

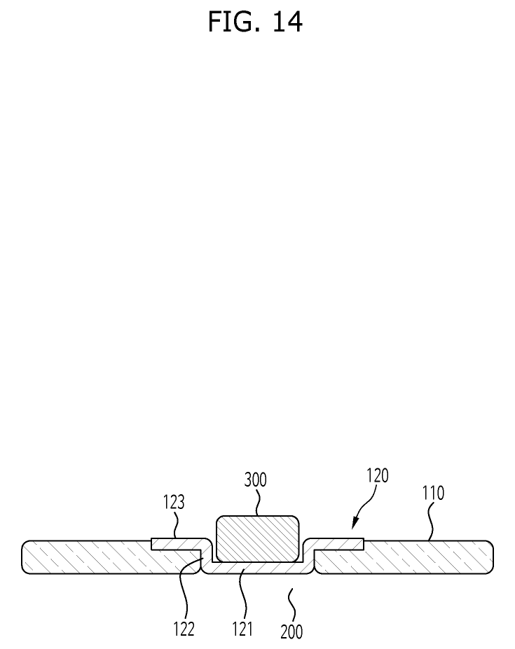

Referring to FIG. 14, in the secondary battery 100 according to some embodiments, as shown in FIG. 11, the center 121 of the first electrode terminal 120 may be inserted and may be fixed into the electrolyte injection port 200, and the extension 123 may be mounted and may be fixed onto the step formed at a portion of the case 110 corresponding to the periphery of the electrolyte injection port 200. In addition, the metal support 300 may be disposed at the center 121 of the first electrode terminal 120. With respect to the metal support 300, the description there of in FIG. 8 and FIG. 13 will be applied.

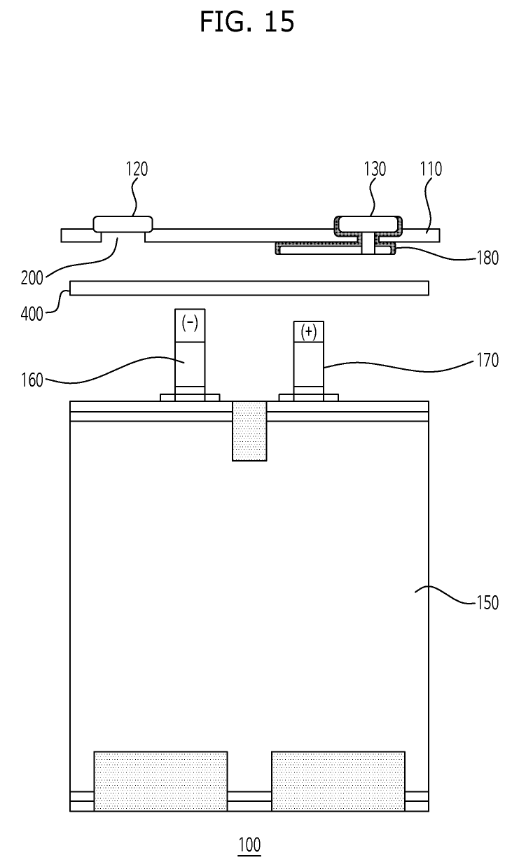

FIG. 15 is a view illustrating an internal structure of the secondary battery 100 according to some embodiments of the present disclosure.

Referring to FIG. 15, the secondary battery 100 may include the electrode assembly 150 including a first electrode, a second electrode, and a separator disposed between the first electrode and the second electrode, the case configured to accommodate the electrode assembly 150 inserted through the opening formed at one end, a cover (not shown) configured to seal the opening of the case 110, and an insulating plate 400 disposed between the electrode assembly 150 and the case 110. The electrolyte injection port 200, the first electrode terminal 120 and the second electrode terminal 130 may be formed on at least one surface of the case 110, and the electrolyte injection port 200 may be sealed by the first electrode terminal 120. The insulating plate 400 may prevent electrical short-circuits or a leakage current between the case 110 or the electrode terminals 120 and 130 and the electrode assembly 150 and may include an insulating material or a high-k material such as polyurethane, polyester, ceramic, etc.

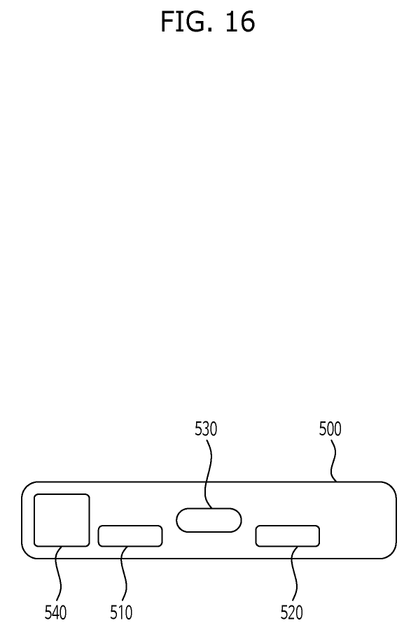

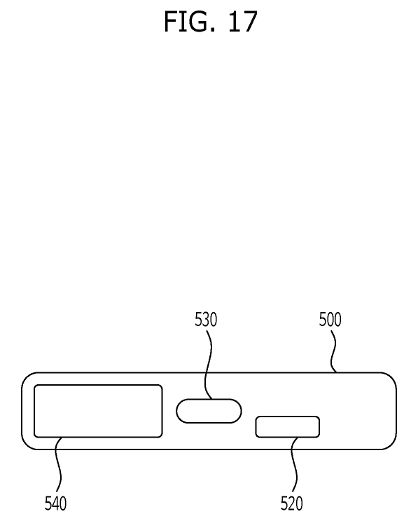

FIG. 16 and FIG. 17 are views illustrating an insulating plate 400 of a secondary battery according to some embodiments of the present disclosure.

Referring to FIG. 16, an insulating plate 400 may include a first electrode hole 510 corresponding to the first electrode and a second electrode hole 520 corresponding to the second electrode. The insulating plate 400 may further include a first electrolyte injection port hole 530 and a second electrolyte injection port hole 540. The first electrolyte injection port hole 530 may correspond to the electrolyte injection port formed in the conventional secondary battery. When the electrolyte injection port is disposed only below the first electrode terminal on one surface of the case 110 of the secondary battery and no additional electrolyte injection port is provided, the first electrolyte injection port hole 530 may not be formed on the insulating plate 400. However, for the purpose of reducing the manufacturing costs of the insulating plate 400, a second electrolyte injection port hole 540 may be added to a conventional insulating plate including the first electrolyte injection port hole 530. As shown in FIG. 15, the first electrolyte injection port hole 530 may be used as an injection passage of an auxiliary electrolyte when the auxiliary electrolyte injection port is further included in addition to the electrolyte injection port disposed below the first electrode terminal on the case 110.

Referring to FIG. 17, the insulating plate 400 may include the second electrolyte injection port hole 540 corresponding to the first electrode and the electrolyte injection port and the second electrode hole 520 corresponding to the second electrode. When the electrolyte injection port is placed below the first electrode terminal on the case 110, the second electrolyte injection port hole 540 may have a shape or a width through which the first electrode terminal penetrates and a large amount of electrolyte flows. The shape of the second electrolyte injection port hole 540 is not limited to the shape shown in FIG. 17, as any shape may be possible as long as the first electrode terminal and the electrolyte pass through.

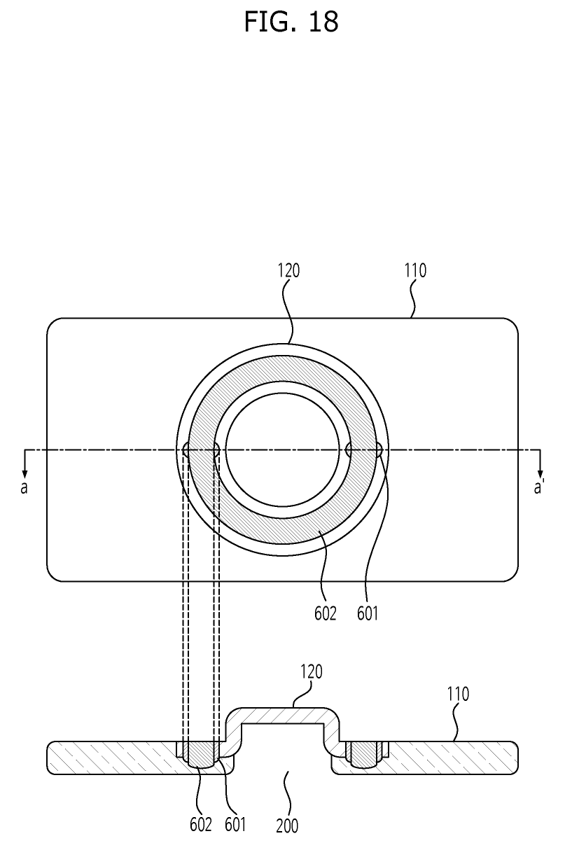

FIG. 18 is a view illustrating a welding shape formed at an electrode terminal of a secondary battery according to some embodiments of the present disclosure.

Referring to FIG. 18, in the secondary battery including the case 110 of which the electrolyte injection port 200 is sealed by the first electrode terminal 120, the first electrode terminal 120 may be coupled to one surface of the case 110 by welding. A portion of the extension of the first electrode terminal 120 may first be welded to one surface of the case 110, and a first welding part 601 including a first welding bead may be formed accordingly. The first welding may be performed to place or mount the extension of the first electrode terminal 120 at the predetermined position of the step of the case 110. After the first welding is completed, the secondary welding may be performed along the outer contour of the shape of the first electrode terminal 120, and a second welding part 602 including a second welding bead may be performed. The second welding may be performed to seal the electrolyte injection port 200 with the extension of the first electrode terminal 120 mounted at the step of the case 110. Through a two-step welding process, the first electrode terminal 120 may be effectively coupled to the electrolyte injection port 200 and a predetermined position of the peripheral area.

The first welding part 601 and the second welding part 602 may be different in a number or a size of welding beads or welding depths. A number or a size of first welding beads may be greater than or smaller than a number or a size of second welding bead. The welding depth of the first welding part 601 may have a shallow depth and narrow width, and the second welding part 602 may be deeper and wider.

Although the present disclosure has been described above with respect to some embodiments of a secondary battery, the present disclosure is not limited thereto. Various modifications and variations of the embodiments disclosed above can be made by those skilled in the art.

### Description of Notable Reference Numbers

100: Secondary Battery

110: Case

120: First Electrode Terminal

130: Second Electrode Terminal

140: Cover

150: Electrode Assembly

160: First Electrode Tab

170: Second Electrode Tab

180: Insulating Layer

200: Electrolyte Injection Port

What is claimed is:

1. A secondary battery, comprising:
an electrode assembly comprising:
a first electrode;
a second electrode; and
a separator disposed between the first electrode and the second electrode;
a case configured to accommodate the electrode assembly such that the electrode assembly is inserted through an opening at one end of the case, the case comprising:
an electrolyte injection port;
a first electrode terminal; and
a second electrode terminal,
wherein the electrolyte injection port is sealed by the first electrode terminal; and
a cover configured to seal the opening of the case.

2. The secondary battery as claimed in claim 1, wherein the first electrode terminal comprises:
a center having a shape corresponding to the electrolyte injection port;
an extension extending outwardly from the center of the first electrode terminal; and
a bending part configured to connect the center of the first electrode terminal to the extension of the first electrode terminal.

3. The secondary battery as claimed in claim 2, wherein a portion of the case corresponding to a periphery of the electrolyte injection port has a step,
wherein the extension of the first electrode terminal is mounted on and fixed to the step, and
wherein an upper surface of the center of the first electrode terminal is positioned at a higher level than an upper surface of the case.

4. The secondary battery as claimed in claim 2, wherein the center of the first electrode terminal is inserted and fixed into the electrolyte injection port,
wherein the extension of the first electrode terminal is mounted on and fixed to a surface of the case corresponding to a periphery of the electrolyte injection port, and
wherein an upper surface of the center of the first electrode terminal is positioned at a lower level than an upper surface of the case.

5. The secondary battery as claimed in claim 2, wherein a horizontal length of the center of the first electrode terminal is greater than a horizontal length of the electrolyte injection port.

6. The secondary battery as claimed in claim 2, wherein a portion of the case corresponding to a periphery of the electrolyte injection port has a step, and
wherein a thickness of the extension of the first electrode terminal is greater than or the same as a depth of the step.

7. The secondary battery as claimed in claim 2, further comprising a metal support placed at the center of the first electrode terminal.

8. The secondary battery as claimed in claim 1, wherein the electrolyte injection port has a polygonal, circular, or oval shape.

9. The secondary battery as claimed in claim 1, wherein a material of at least one of the case and the cover includes stainless use steel.

10. The secondary battery as claimed in claim 1, further comprising an auxiliary electrolyte injection port formed between the first electrode terminal and the second electrode terminal on at least one surface of the case.

11. The secondary battery as claimed in claim 1, wherein the first electrode is electrically connected to the case.

12. A secondary battery, comprising:
an electrode assembly comprising:
a first electrode;
a second electrode; and
a separator disposed between the first electrode and the second electrode;
a case configured to accommodate the electrode assembly inserted through an opening formed at one end of the case, the case comprising:
an electrolyte injection port;
a first electrode terminal; and
a second electrode terminal,
wherein the electrolyte injection port is sealed by the first electrode terminal;
a cover configured to seal the opening of the case; and
an insulating plate placed between the electrode assembly and the case.

13. The secondary battery as claimed in claim 12, wherein the insulating plate comprises:
a first electrode hole corresponding to the first electrode; and
a second electrode hole corresponding to the second electrode.

14. The secondary battery as claimed in claim 12, wherein the first electrode terminal comprises:
a center having a shape corresponding to the electrolyte injection port;
an extension extending outwardly from the center of the first electrode terminal; and
a bending part that connects the center of the first electrode terminal to the extension of the first electrode terminal.

15. The secondary battery as claimed in claim 14, wherein a portion of the case corresponding to a periphery of the electrolyte injection port has a step,
wherein the extension of the first electrode terminal is mounted on and fixed to the step, and
wherein an upper surface of the center of the first electrode terminal is positioned at a higher level than an upper surface of the case.

16. The secondary battery as claimed in claim 14, wherein the center of the first electrode terminal is inserted and fixed into the electrolyte injection port,
wherein the extension of the first electrode terminal is mounted on and fixed to a surface of the case corresponding to a periphery of the electrolyte injection port, and
wherein an upper surface of the center of the first electrode terminal is positioned at a lower level than an upper surface of the case.

17. The secondary battery as claimed in claim 14, wherein a horizontal length of the center of the first electrode terminal is greater than a horizontal length of the electrolyte injection port.

18. The secondary battery as claimed in claim 14, wherein a portion of the case corresponding to a periphery of the electrolyte injection port has a step, and
wherein a thickness of the extension of the first electrode terminal is greater than or the same as a depth of the step.

19. The secondary battery as claimed in claim 12, wherein the electrolyte injection port has a polygonal, circular, or oval shape.

20. The secondary battery as claimed in claim 12, further comprising:
an auxiliary electrolyte injection port formed between the first electrode terminal and the second electrode terminal on at least one surface of the case,
wherein the insulating plate comprises an electrolyte injection port hole corresponding to the auxiliary electrolyte injection port.
